(19) United States
(12) Patent Application Publication
(10) Pub. No.: US 2007/0134565 A1
(43) Pub. Date: Jun. 14, 2007

(54) COLOR FILTER MASK LAYOUT

(76) Inventor: Jae Hyun Kang, Gyeonggi-do (KR)

Correspondence Address: SHERR & NOURSE, PLLC, 620 HERNDON PARKWAY, SUITE 200, HERNDON, VA, 20170, US

(21) Appl. No.: 11/608,568

(22) Filed: Dec. 8, 2006

(30) Foreign Application Priority Data
Dec. 14, 2005 (KR) 10-2005-0123362

(51) Int. Cl. G02B 5/20

(52) U.S. Cl. 430/5; 430/7

(57) ABSTRACT

Embodiments relate to a color filter mask layout that may be capable of reducing an SNR by preventing an occurrence of a corner rounding during manufacturing of a color filter. In embodiments, a color filter mask layout may include a blue color filter mask pattern disposed at a center part, a red color filter mask pattern disposed in a diagonal direction of the blue color filter mask pattern to be spaced apart from the blue color filter mask pattern, a green color filter mask pattern disposed in a diagonal direction of the blue color filter mask pattern to be spaced apart from the blue color filter mask pattern, and a correction mask pattern for an optical proximity correction installed at a corner of the green color filter mask pattern.

The present application claims priority under 35 U.S.C. 119 and 35 U.S.C. 365 to Korean Patent Application No. 10-2005-0123362 (filed on Dec. 14, 2005), which is hereby incorporated by reference in its entirety.

### BACKGROUND

An image sensor may be a semiconductor device, and may transform an optical image to electrical signals. Image sensors may generally be classified as either a charge coupled device (CCD) or a CMOS image sensor.

A CCD may have a complicated driving method, may have high power consumption, and may require a complicated fabrication process involving multiple photo process stages. In this sense, a CCD may be disadvantageous.

A CMOS image sensor may be a next generation image sensor, and may not suffer from the CCD disadvantages described above.

The CMOS image sensor may have a photo diode and a MOS transistor formed within each unit pixel. The CMOS image sensor may monitor a switching of the MOS transistors, and may thereby successively detect electric signals from the photo diodes of the unit pixels to reproduce an image.

FIG. 1 is an example related art color filter mask layout for manufacturing a CMOS image sensor.

Referring to FIG. 1, blue color filter mask pattern 15 may be disposed at a center part of the mask, red color filter mask patterns 11 may be disposed in diagonal directions relative to the blue color filter mask pattern 15, and green color filter mask patterns 13 may be disposed in vertical and horizontal directions relative to the blue color filter mask pattern 15. Hence, red color filter mask patterns 11 may be provided at corners of the color filter mask layout, green color filter mask patterns 13 may be provided at edges of the color filter mask layout that are not corners, and blue color filter mask pattern 15 may be provided in the center of the color filter mask layout. Each color filter mask pattern may be substantially in the form of a square.

FIG. 2 illustrates an example related art simulation result, which exemplifies a color filter resist pattern formed using the mask layout of FIG. 1. FIG. 3 is a partially enlarged view of FIG. 2.

Specifically, FIG. 3 is an enlarged view of reference numeral 19 of FIG. 2. For comparison of FIG. 2 and FIG. 3, elements of a color filter mask pattern and elements of a color register pattern are designated by the same reference numerals.

A color filter may be patterned by a photolithography process using the color filter mask layout of FIG. 1. Corner parts of the color resist patterns 15, 11, and 13 may be rounded when this process is employed. Accordingly, referring to FIG. 2 and FIG. 3, there may be empty spaces 17 at interfaces of the three color resist patterns 15, 11, and 13.

In the related art, empty space 17 may be shown in reference numeral 21 of FIG. 3. When white light, for example that has passed through a micro lens (not shown), passes through empty space 17 (e.g. in which color filters are absent), white light may be transferred to a lower photo diode, and may thereby increase a signal to nose ratio (“SNR”).

Furthermore, according to the related art, empty space 17 may cause the distortion of an image and reduce the resolution thereof.

### SUMMARY

Embodiments relate to a color filter mask layout of a complementary metal oxide silicon (CMOS) image sensor.

In embodiments, a color filter mask layout may reduce an SNR by preventing an occurrence of corner rounding during manufacturing of a color filter.

In embodiments, a color filter mask layout may prevent image distortion by preventing the occurrence of corner rounding during manufacturing of a color filter.

In embodiments, a color filter mask layout may include a blue color filter mask pattern disposed at a center part, a red color filter mask pattern disposed in a diagonal direction of the blue color filter mask pattern to be spaced apart from the blue color filter mask pattern, a green color filter mask pattern disposed in a diagonal direction of the blue color filter mask pattern to be spaced apart from the blue color filter mask pattern, and a correction mask pattern for an optical proximity correction installed at a corner of the green color filter mask pattern.

In embodiments, a color filter mask layout may include a blue color filter mask pattern disposed at a center part, a red color filter mask pattern disposed in a diagonal direction of the blue color filter mask pattern to be spaced apart from the blue color filter mask pattern, a green color filter mask pattern disposed in a diagonal direction of the blue color filter mask pattern to be spaced apart from the blue color filter mask pattern, and a first correction mask pattern for an optical proximity correction installed at a corner of the blue color filter mask pattern.

In embodiments, a color filter mask layout may include a blue color filter mask pattern disposed at a center part, a red color filter mask pattern disposed in a diagonal direction of the blue color filter mask pattern to be spaced apart from the blue color filter mask pattern, a green color filter mask pattern disposed in a diagonal direction of the blue color filter mask pattern to be spaced apart from the blue color filter mask pattern, and a correction mask pattern for an optical proximity correction installed at a corner of the red color filter mask pattern.

### BRIEF DESCRIPTION OF THE DRAWINGS

FIG. 1 is an example drawing illustrating a related art color filter mask layout;

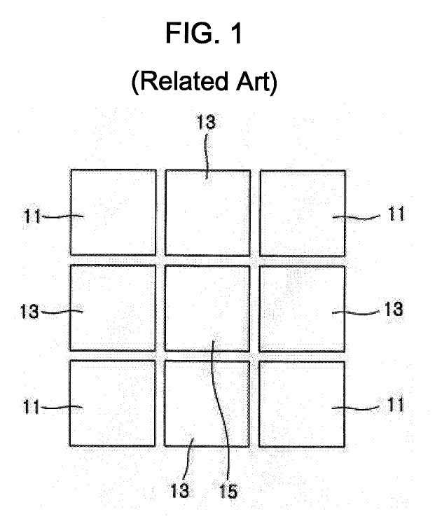

FIG. 2 is an example drawing illustrating a related art simulation result, which exemplifies a color filter resist pattern formed using the mask layout of FIG. 1;

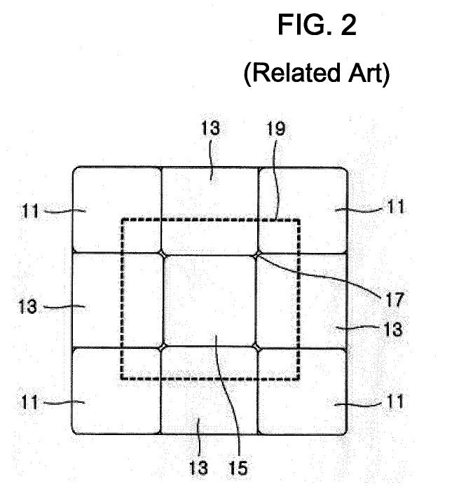

FIG. 3 is a partially enlarged view of FIG. 2;

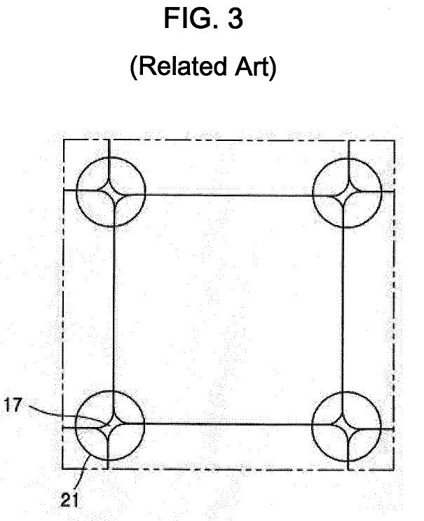

FIG. 4 is an example drawing illustrating a color filter mask layout according to embodiments;

FIG. 5 is an example drawing illustrating a simulation result, which identifies a color filter resist pattern formed this using the mask layout of FIG. 4;

FIG. 6 is a partially enlarged view of FIG. 5;

FIG. 7 is an example drawing illustrating a color filter mask layout according to embodiments;

FIG. 8 is an example drawing illustrating a color filter mask layout according to embodiments; and

FIG. 9 is an example drawing illustrating a color filter mask layout according to embodiments.

### DETAILED DESCRIPTION OF EMBODIMENTS

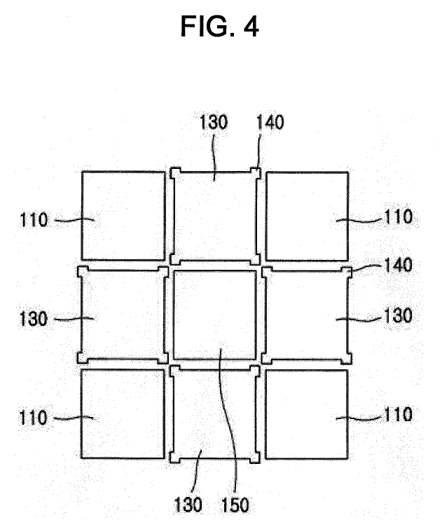

FIG. 4 is an example drawing illustrating a color filter mask layout according to embodiments.

According to embodiments, a color filter mask layout may be formed in an order of a blue color filter mask pattern, a red color filter mask pattern, and a green color filter mask pattern. However, embodiments are not limited thereto. Additionally, each color mask pattern may be formed of one or more color masks.

For example, in embodiments, a color filter mask layout may be formed in the order of a blue color filter mask pattern, a green color filter mask pattern, and a red color filter mask pattern.

In embodiments, the blue color filter mask pattern may be formed first. If the blue color filter mask pattern is formed after other color filter mask patterns, it may damage the other color filter mask patterns.

Referring to FIG. 4, according to embodiments blue color filter mask pattern 150 may be disposed at a center part of the mask pattern, and may be formed substantially in a shape of a square.

Red color filter mask pattern 110 may be disposed in diagonal directions relative to the blue color filter mask pattern 150, and may be spaced apart from blue color filter mask pattern 150.

Green color filter mask pattern 130 may be disposed in vertical and horizontal directions relative to blue color filter mask pattern 150 (substantially above and below and to the left and right of blue color filter mask pattern 150), and may be spaced apart from blue color filter mask pattern 150. Hence, red color filter mask patterns 110 may be provided at corners of the color filter mask layout, green color filter mask patterns 130 may be provided at edges of the color filter mask layout that are not corners, and blue color filter mask pattern 150 may be provided in the center of the color filter mask layout. Each color filter mask pattern may be substantially in the form of a square. The color layout may be used in various described embodiments

In embodiments, correction mask pattern 140 may be used for optical proximity correction. Correction mask pattern may be provided at a corners of green color filter mask pattern 130, in which the most green color filter mask pattern 130 may be formed of blue color filter mask pattern 150, red color filter mask pattern 110, and green color filter mask pattern 130.

A serif may be used as correction mask pattern 140. Correction mask pattern 140 may prevent corner rounding from occurring.

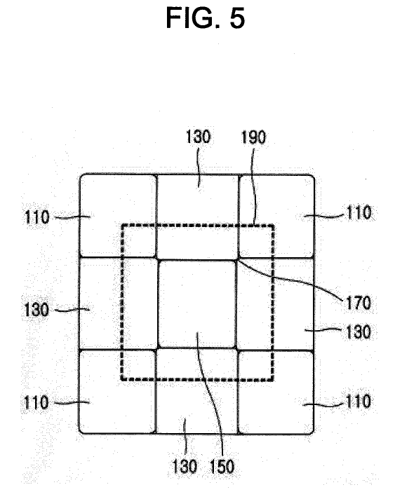

As illustrated in FIG. 4, by applying rule based optical proximity correction (OPC), when serif correction mask pattern 140 is formed at green color filter mask pattern 130, an empty space between the color filter mask patterns with the green color filter resist pattern 130 (FIG. 5) after patterning may be reduced or filled.

In embodiments, serif mask pattern 140 may have a same e as that of green color filter mask pattern 130.

Further, serif mask pattern 140 may have a relative size ranging from 1/30 through 3/20 the size of green color filter mask pattern 130. Such size may be useful to prevent corner rounding. For example, according to embodiments, when serif correction mask pattern 140 has a size of 1/20 of green color filter mask pattern 130, it may effectively prevent corner rounding.

In accordance with embodiments, an OPC may be applied to one color filter mask pattern in the color filter mask layout. Accordingly, the OPC may not significantly influence a manufacturing cost of the color filter mask.

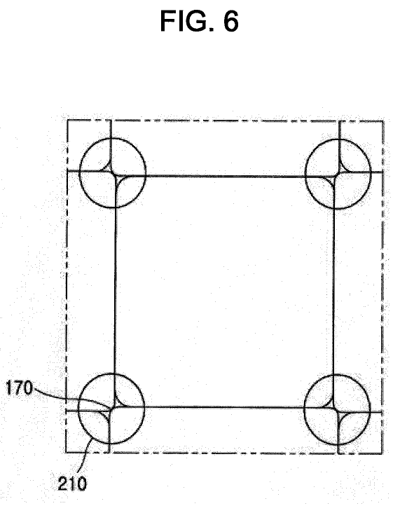

FIG. 5 is an example drawing illustrating a simulation result, which exemplifies a color filter resist pattern formed using the mask layout of FIG. 4. FIG. 6 is a partially enlarged view of FIG. 5.

Specifically, FIG. 6 is an enlarged view of reference numeral 190 of FIG. 5. For comparison of FIG. 4 and FIG. 5, a color filter mask pattern and a color register pattern are designated by the same reference numeral.

Thus referring to FIG. 5, reference numeral 150 may represents a blue color resist pattern that may be disposed at a center part. Reference numeral 110 may be a red color resist pattern disposed in diagonal directions of the blue color resist pattern 150. Reference numeral 130 may be a green color resist pattern disposed in horizontal and vertical directions relative to the blue color resist pattern.

In embodiments, a color filter may be patterned by a photolithography process while having a color filter mask layout of FIG. 5. Empty spaces 150 that may occur in corners of the color resist patterns 150, 110, and 130 may be filled with the green color resist pattern 130 by the OPC due to correction mask pattern 140. The empty spaces 170 are illustrated in reference numeral 210 of FIG. 6.

In embodiments, the OPC may be applied to one color filter mask pattern in the color filter mask layout. Accordingly, it may not significantly influence a manufacturing cost of the color filter mask.

Accordingly, when a color filter manufactured by the color filter mask layout according to embodiments is used, white light, for example that may have passed through a micro lens (not shown), may be prevented from transferring to a lower photo diode. SNR may thereby be reduced.

Furthermore, according to embodiments, a distortion of an image and a deterioration of a resolution thereof may be reduced or prevented.

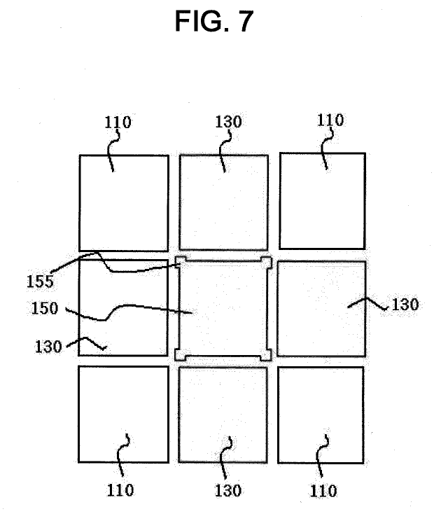

FIG. 7 is an example drawing illustrating a color filter mask layout according to embodiments.

Referring to FIG. 7, according to embodiments a color filter mask layout may include a color or pattern layout described with respect to FIG. 4. Color filter mask layout may include first correction mask pattern 155, that may be provided at a corner of blue color filter mask pattern 150 for the OPC.

A color filter maybe patterned by a photolithography process while having a color filter mask layout of FIG. 7. Empty spaces 170 in corners of the color resist patterns 150, 110, and 130 may be filled with the blue color resist pattern 155 by the OPC due to the correction mask pattern 155.

In embodiments, when viewing an enlarged color filter mask layout of FIG. 7, first correction mask pattern 155 may be formed at corners of blue color filter mask pattern 150 for the OPC. Consequently, first correction mask pattern 155 may be disposed at corners, for example inside corners, of all color filter mask patterns, namely, blue, green, and red color filter mask patterns 150, 130, 110, and may prevent corner rounding.

Moreover, according to embodiments, because the OPC is applied to one color filter mask pattern in the color filter mask layout, it may not significantly influence a manufacturing cost of the color filter mask.

When a color filter manufactured by the color filter mask layout according to embodiments is used, white light, for example that may have passed through a micro lens (not shown), may be prevented from transferring to a lower photo diode, and SNR may thereby be reduced.

Furthermore, according to embodiments, a distortion of an image and a deterioration of a resolution thereof may be reduced or prevented.

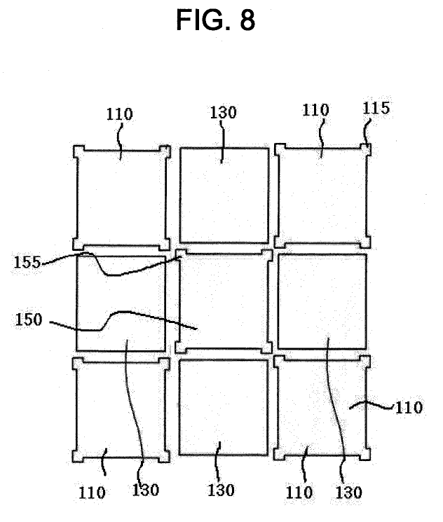

FIG. 8 is an example drawing illustrating a color filter mask layout according to embodiments

Referring to FIG. 8, according to embodiments a color filter mask layout may include first correction mask pattern 155 installed at corners of blue color filter mask pattern 150 for the OPC. Further, second correction mask pattern 115 may be formed at corners of red color filter mask pattern 110.

According to embodiments, a color filter may be patterned by a photolithography process while having a color filter mask layout of FIG. 8. Empty spaces 170 in corners of the color resist patterns 150, 110, and 130 may be filled with blue color resist pattern 155 and red color resist pattern 115 by the OPC due to first correction mask pattern 155 and second correction mask pattern 115.

Thus, in addition to first correction mask pattern 155 that may be installed at corners of blue color filter mask pattern 150 for the OPC, second correction mask pattern 115 may be formed at a corner of red color filter mask pattern 110. Thus, first correction mask pattern 155 and second correction mask pattern 115 may be provided at corners, for example inside corners, of all the color filter mask patterns, namely, blue, green, and red color filter mask patterns 150, 130, 110, and may prevent the formation of the corner rounding.

According to embodiments, white light, for example that may have passed through a micro lens (not shown), may be prevented from transferring to a lower photo diode, and SNR may thereby be reduced.

Furthermore, according to embodiments, a distortion and resolution deterioration of an image may be reduced or prevented.

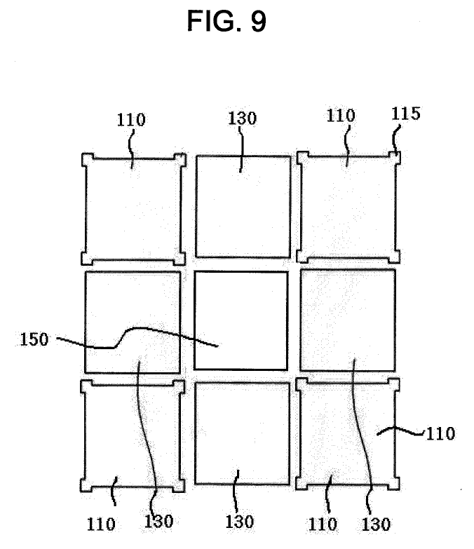

FIG. 9 is an example drawing illustrating a color filter mask layout according to embodiments.

According to embodiments, a color filter mask layout may include correction mask pattern 115 installed at corners of red color filter mask pattern 110 for the OPC.

According to embodiments, a color filter may be patterned by a photolithography process while having a color filter mask layout of FIG. 9. Empty spaces 170 in corners of the color resist patterns 150, 110, and 130 may be filled with red color resist pattern 115 by the OPC due to the correction mask pattern 155.

In embodiments, correction mask pattern 115 may be formed at corners of red color filter mask pattern 110 for the OPC. Consequently, correction mask pattern 115 may be effectively positioned at corners, for example inside corners, of all color filter mask patterns, namely, blue, green, and red color filter mask patterns 150, 130, 110, and may prevent corner rounding.

According to embodiments, because the OPC may be applied to one color filter mask pattern in the color filter mask layout, it may not significantly influence a manufacturing cost of the color filter mask.

According to embodiments, white light, for example that may have passed through a micro lens (not shown), may not be transferred to a lower photo diode, and SNR may thereby be reduced.

According to embodiments, a distortion of an image and deterioration of the resolution thereof may be reduced or prevented.

It will be apparent to those skilled in the art that various modifications and variations can be made to embodiments. Thus, it is intended that embodiments cover modifications and variations thereof within the scope of the appended claims. It is also understood that when a layer is referred to as being “on” or “over” another layer or substrate, it can be directly on the other layer or substrate, or intervening layers may also be present.

What is claimed is:

1. A mask layout comprising:
a blue color filter mask pattern;
a red color filter mask pattern;
a green color filter mask; and
a correction mask pattern configured to provide optical proximity correction and formed on at least one corner of at least one of the green, blue, and red color filter mask patterns.

2. The mask layout of claim 1, wherein the blue color filter mask pattern is disposed in a center region of the mask.

3. The mask layout of claim 1, wherein the red color filter mask pattern is disposed in a diagonal direction relative to the blue color filter mask pattern and spaced apart from the blue color filter mask pattern.

4. The mask layout of claim 1, wherein the green color filter mask pattern is disposed in at least one of a vertical and horizontal direction relative to the blue color filter mask pattern and spaced apart from the blue color filter mask pattern.

5. The mask layout of claim 1, wherein the correction mask pattern comprises a serif.

6. The mask layout of claim 5, wherein the correction mask pattern is formed on the green color filter mask pattern.

7. The mask layout of claim 6, wherein the serif has a phase that is substantially identical to a phase of the green color filter mask pattern.

8. The mask layout of claim 5, wherein the blue color filter mask pattern, the red color filter mask pattern, and the green color filter mask pattern comprise a square.

9. The mask layout of claim 5, wherein the serif comprises a square.

10. The mask layout of claim 5, wherein four serifs are formed at corners of the at least one green, blue, and red color filter mask pattern on which the correction mask pattern is formed.

11. The mask layout of claim 5, wherein the serif has a size of 1/30 through 3/20 of a size of the green color filter mask pattern on which it is formed.

12. The mask layout of claim 5, wherein the serif has a phase that is substantially identical to a phase of the at least one green, blue, and red color filter mask pattern on which it is formed.

13. A mask layout comprising:
a blue color filter mask pattern;
a plurality of red color filter mask patterns;
a plurality of green color filter mask patterns; and
a first correction mask pattern configured to provide optical proximity correction and provided on at least one corner of at least one of the blue, green, and red color filter mask patterns.

14. The mask layout of claim 13, wherein the blue color filter mask is disposed in a center region of the mask.

15. The mask layout of claim 14, wherein the plurality of red color filter masks are disposed in diagonal directions relative to the blue color filter mask pattern and spaced apart from the blue color filter mask pattern.

16. The mask layout of claim 15, wherein the plurality of green color filter masks are disposed in vertical and horizontal directions relative to the blue color filter mask pattern and spaced apart from the blue color filter mask pattern, and wherein the blue color filter mask pattern, the plurality of red color filter mask patterns, and the plurality of green color filter mask patterns comprise a square.

17. The mask layout of claim 13, wherein the correction mask pattern comprises a serif.

18. A mask layout comprising:
a blue color filter mask pattern;
a red color filter mask pattern disposed in a diagonal direction relative to the blue color filter mask pattern and spaced apart from the blue color filter mask pattern;
a green color filter mask pattern disposed in at least one of a vertical and horizontal direction relative to the blue color filter mask pattern and spaced apart from the blue color filter mask pattern; and
a correction mask pattern configured to provide optical proximity correction and formed on at least one corner of at least one of the red, blue, and green color filter mask pattern.

19. The mask layout of claim 18, wherein the correction mask pattern comprises a square serif.

20. The mask layout of claim 18, wherein the blue color filter mask pattern, the red color filter mask pattern, and the green color filter mask pattern comprise a square.
